(19) United States
(12) Patent Application Publication
(10) Pub. No.: US 2025/0110850 A1
(43) Pub. Date: Apr. 3, 2025

(54) Evaluating Computer-Readable Code

(71) Applicant: Google LLC, Mountain View, CA (US)

(72) Inventors: Indu Ramamurthi, Los Altos, CA (US); Ryan Kam Wang Tai, Sunnyvale, CA (US); Karen Chia Lin Yao, Los Altos, CA (US)

(73) Assignee: Google LLC, Mountain View, CA (US)

(21) Appl. No.: 18/900,075

(22) Filed: Sep. 27, 2024

Related U.S. Application Data
(60) Provisional application No. 63/586,934, filed on Sep. 29, 2023.

(51) Int. Cl. G06F 11/36

(52) U.S. Cl. CPC G06F 11/3608

(57) ABSTRACT

Techniques are described for evaluating computer-readable code. In example aspects, a machine-learned model is trained to evaluate computer-readable code and/or its corresponding code description. As part of the evaluation, the machine-learned model can determine a level of agreement between the code description and the computer-readable code. Additionally or alternatively, the machine-learned model can determine that a prohibited feature is absent from (or present in) the computer-readable code. If present, the prohibited feature can compromise a security of a device that executes the computer-readable code, a safety of a user operating the device, and/or the user's privacy. Additionally or alternatively, the prohibited feature can violate a policy of a manufacturer of the device. With this machine-learned model, the manufacturer can efficiently evaluate computer-readable code and code descriptions that are provided by a third-party developer and can determine whether to make the third-party software available to users via a digital distribution platform.

### CROSS-REFERENCE TO RELATED APPLICATION(S)

This application claims the benefit of U.S. Provisional Patent Application Ser. No. 63/586,934, filed on Sep. 29, 2023, the disclosure of which is incorporated by reference herein in its entirety.

### BACKGROUND

Computing devices can provide a variety of features and functionality that make everyday life easier for users. Many computing devices enable a user to download and run software that is developed by someone other than a manufacturer of the computing device. While third-party software can provide many additional features that are beneficial to the user, third-party software also has some inherent risks. Some third-party software, for instance, may be developed by an inexperienced developer or a developer with malicious intent. Downloading and/or running this third-party software can potentially compromise a security of the computing device, compromise a safety of the user operating the computing device, compromise the user's privacy, and/or violate a policy of the manufacturer of the computing device. The user may therefore forego installing and utilizing third-party software, which can degrade user satisfaction with the computing device and can result in the computing device being underutilized.

### SUMMARY

Techniques are described for evaluating computer-readable code. In example aspects, a machine-learned model is trained to evaluate computer-readable code and/or its corresponding code description. As part of the evaluation, the machine-learned model can determine a level of agreement between the code description and the computer-readable code. Additionally or alternatively, the machine-learned model can determine that a prohibited feature is absent from (or present in) the computer-readable code. If present, the prohibited feature can compromise a security of a device that executes the computer-readable code, can compromise a safety of a user operating the device, can compromise the user's privacy, or can violate a policy of a manufacturer of the device. With this machine-learned model, the manufacturer can efficiently evaluate computer-readable code and/or code descriptions that are provided by a third-party developer. Based on the evaluation, the manufacturer can determine whether to make the third-party software available to users via a digital distribution platform.

Aspects described below include a method performed by a machine-learned model for evaluating computer-readable code. The method includes receiving, from a first source, a computer-readable code and a corresponding code description. The code description includes a plain-text description of a purpose of the computer-readable code. The method also includes receiving a second code description that is generated by a second source based on the computer-readable code. The second source is independent from the first source. The second code description includes a plain-text description of the purpose of the computer-readable code. The method additionally includes performing at least one of the following: (1) determining a level of agreement between the code description and the second code description based on a comparison of the code description with the second code description; or (2) determining that a prohibited feature is absent from the computer-readable code.

Aspects described below also include an apparatus comprising a machine-learned model. The machine-learned model is configured to perform any of the described methods.

Aspects described below include a computer-readable storage medium comprising computer-executable instructions that, responsive to execution by a processor, implement a machine-learned model capable of performing any one of the described methods.

Aspects described below also include a system with means for evaluating computer-readable code.

### BRIEF DESCRIPTION OF DRAWINGS

Apparatuses for and techniques for evaluating computer-readable code are described with reference to the following drawings. The same numbers are used throughout the drawings to reference like features and components:

FIG. 1 illustrates an example environment in which techniques for evaluating computer-readable code can be implemented;

FIG. 2 illustrates example elements of a code description;

FIG. 3 illustrates an example home automation system;

FIG. 4 illustrates an example device capable of executing computer-readable code; FIG. 5 illustrates an example computing device capable of evaluating computer-readable code;

FIG. 6 illustrates an example implementation of a code evaluator capable of evaluating computer-readable code;

FIG. 7 illustrates an example implementation of an evaluation stage of a code evaluator for evaluating computer-readable code;

FIG. 8 illustrates a logical flow of a first example home-automation script;

FIG. 9 illustrates a logic flow of a second example home-automation script;

FIG. 10 illustrates a logic flow of a third example home-automation script;

FIG. 11 depicts an example method for evaluating computer-readable code; and

FIG. 12 illustrates an example computing system embodying, or in which techniques can be implemented that enable use of, evaluating computer-readable code.

### DETAILED DESCRIPTION

A user may forego installing and utilizing third-party software to avoid risks associated with security, safety, privacy, or policy violations. To address this issue, some manufacturers of computing devices provide users access to an online store, which serves as a digital distribution platform for a variety of software. Some of the software available via the online store can include third-party software, which has been vetted through the manufacturer's review and approval process. In this way, the manufacturer can provide a safe and trusted means for the user to discover and utilize third-party software.

In many situations, the manufacturer hires someone (e.g., a software engineer) to review and approve third-party software for the online store. As part of the review process, this person can manually verify that a description of the code, as provided by the third party, properly and correctly conveys a function of the code itself. This person can also manually verify that the code does not present a threat to the computing device, does not present a threat to the user operating the computing device, and/or does not violate a policy of the manufacturer. While this review process can increase a user's confidence that the third-party software made available on the online store is safe to use, the manual aspects of this process can be time consuming and expensive.

To address this challenge, techniques are described for evaluating computer-readable code. In example aspects, a machine-learned model is trained to evaluate computer-readable code and/or its corresponding code description. As part of the evaluation, the machine-learned model can determine a level of agreement between the code description and the computer-readable code. Additionally or alternatively, the machine-learned model can determine that a prohibited feature is absent from (or present in) the computer-readable code. If present, the prohibited feature can compromise a security of a device that executes the computer-readable code, can compromise a safety of a user operating the device, can compromise the user's privacy, or can violate a policy of a manufacturer of the device. With this machine-learned model, the manufacturer can efficiently evaluate computer-readable code and/or code descriptions that are provided by a third-party developer. Based on the evaluation, the manufacturer can determine whether to make the third-party software available to users via a digital distribution platform. The methodology disclosed herein allows for the review and/or approval process to be performed by a non-expert, by an expert in less time than a manual review process, completely autonomously, or some combination of these options.

### Operating Environment

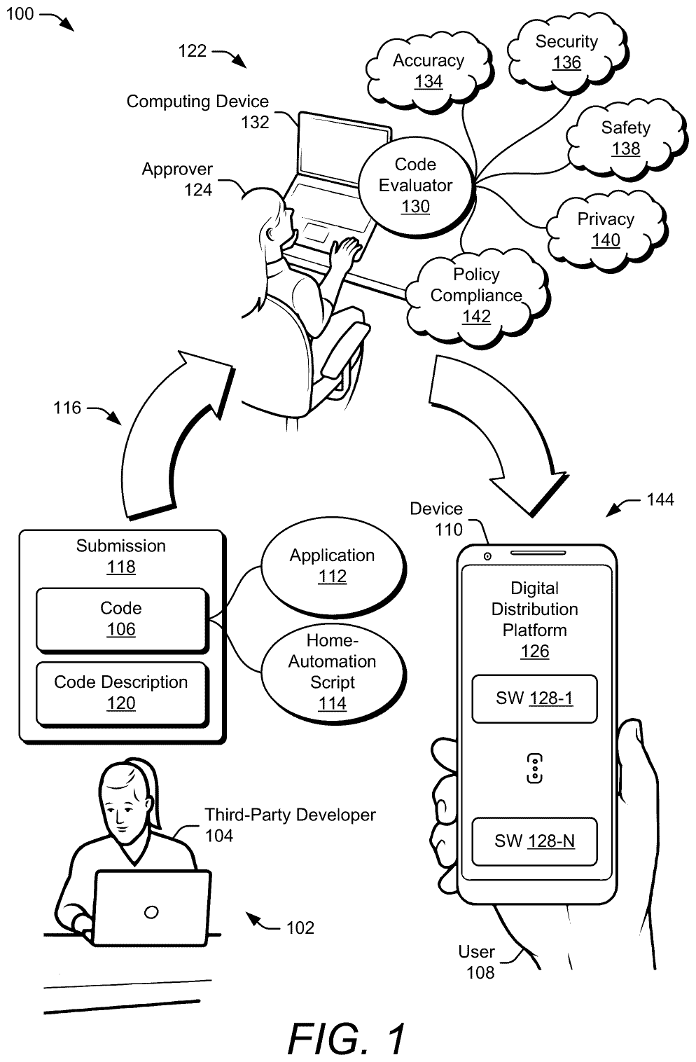

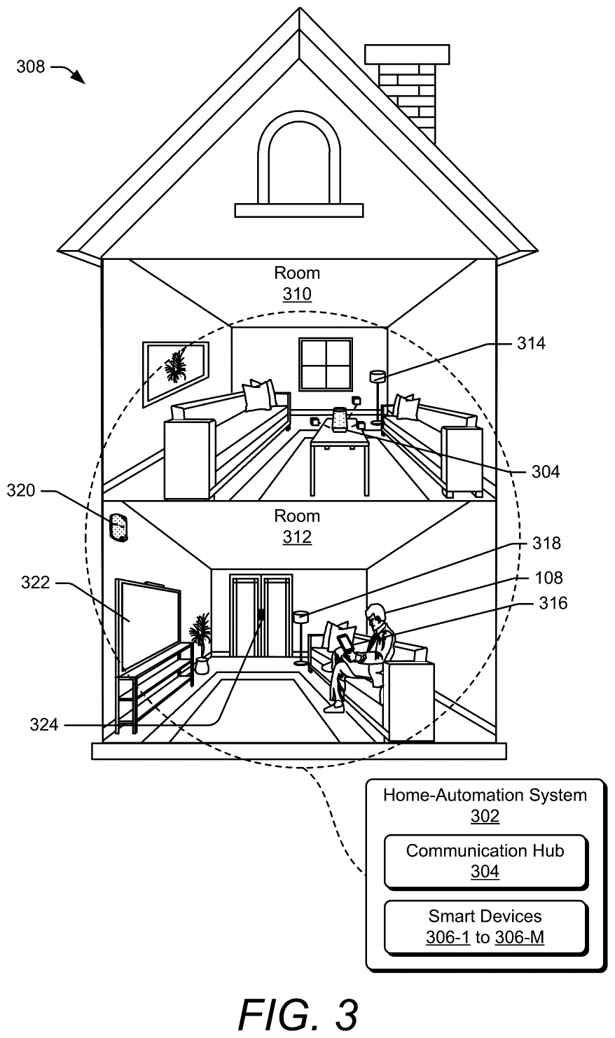

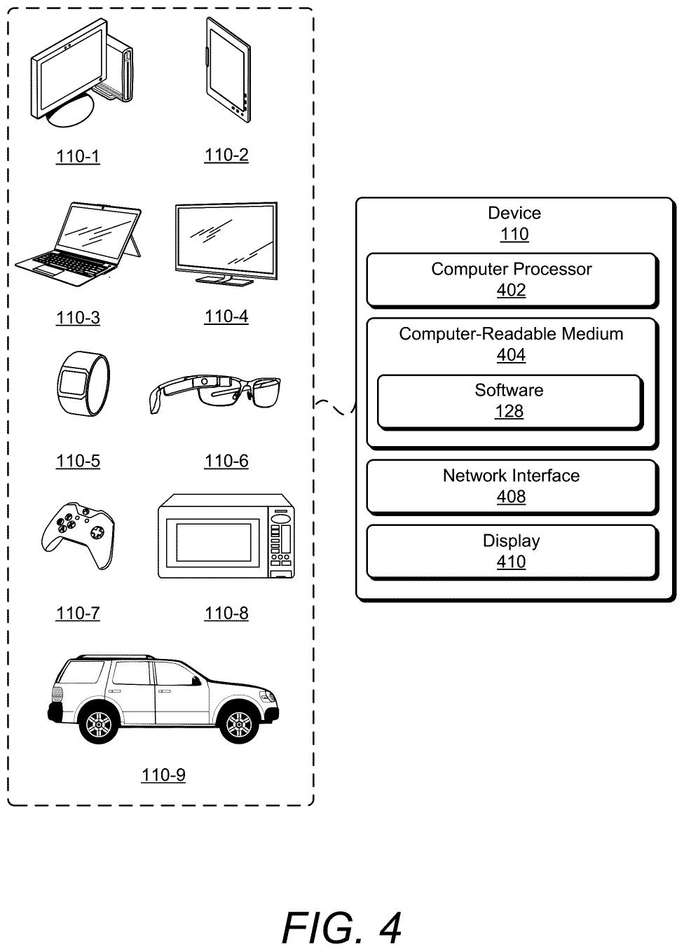

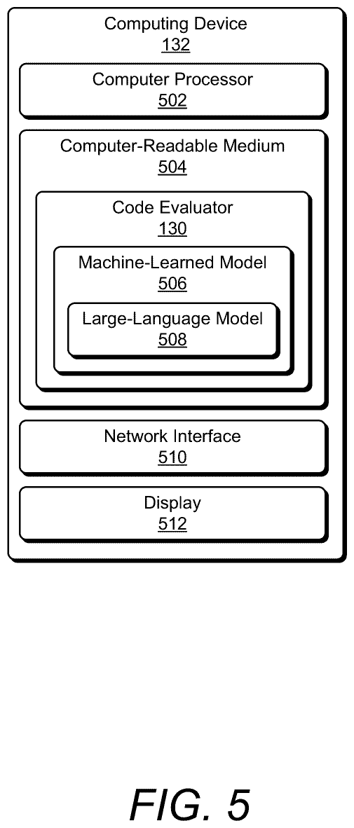

FIG. 1 is an illustration of an example environment 100 in which techniques for evaluating computer-readable code can be implemented. At 102, a third-party developer 104 develops code 106 (e.g., computer-readable code or software) that can be made available to a user 108 and is capable of being executed on a device 110. The device 110 can include a computing device, such as a smartphone shown in FIG. 1, or a home-automation system. Example computing devices and home-automation systems are further described with respect to FIGS. 3 and 4, respectively.

The code 106 can represent an application 112 and/or a home-automation script 114. In some cases, the home-automation script 114 is in the form of a template, which has elements that can be filled in, specified, or further customized by the user 108. The code 106 can be written in any type of software programming language. In an example home automation script 114, the code 106 can be written using YAML. YAML stands for “yet another markup language” and is a type of human-readable data serialization language.

The third-party developer 104 represents someone other than a manufacturer of the device 110. Generally speaking, the manufacturer can be a company that assembles the device 110 and/or a developer of the device 110's operating system. The skill levels of third-party developers 104 can vary. In some cases, the third-party developer 104 is an individual who is a first-time programmer. In other cases, the third-party developer 104 is another company with a team of experienced software engineers. To increase the distribution of the code 106, the third-party developer 104 may choose to submit the code 106 to the manufacturer of the device 110.

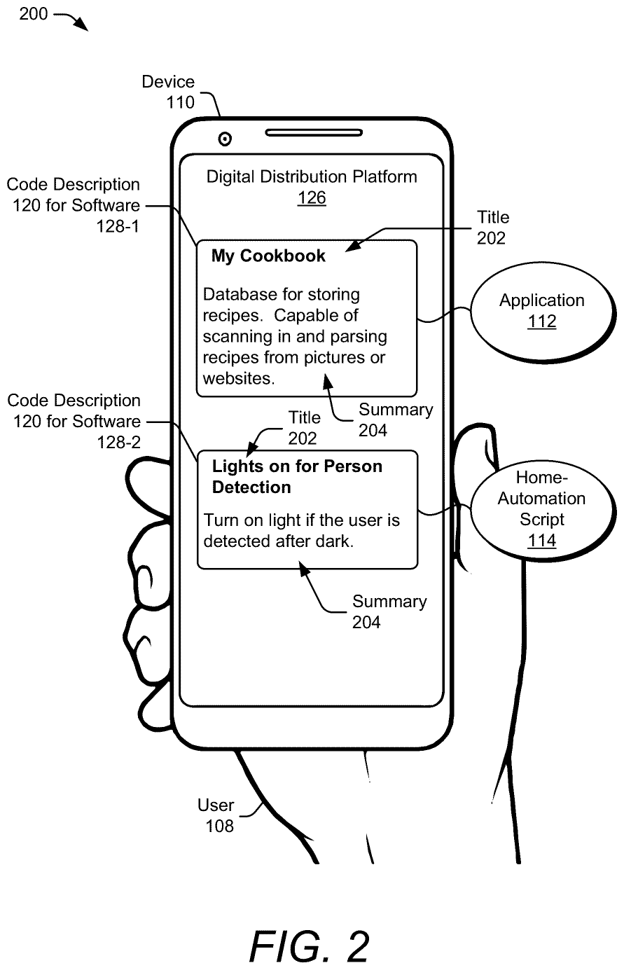

At 116, the third-party developer 104 provides a submission 118 (e.g., a code submission) to the manufacturer. The submission 118 includes the code 106 and a corresponding code description 120. The code description 120 is plain-text that describes a purpose of the code 106. Elements of the code description 120 are further described with respect to FIG. 2.

At 122, an approver 124 determines whether to approve or deny the submission 118 from the third-party developer 104. The approver 124 can be someone that is hired or contracted by the manufacturer of the device 110. If the submission 118 is approved, the code 106 and the code description 120 can be made available on a digital distribution platform 126.

The digital distribution platform 126 can be an online store or a website that is accessible to the user 108 via the device 110 or another device. In some cases, the digital distribution platform 126 is hosted on a server that is owned by the manufacturer of the device 110. The digital distribution platform 126 enables users 108 to download code that has been approved by the manufacturer of the device 110. In the example shown in FIG. 1, software (SW) 128-1 to 128-N represents code that has been previously vetted and approved by the manufacturer. The variable N represents a positive integer.

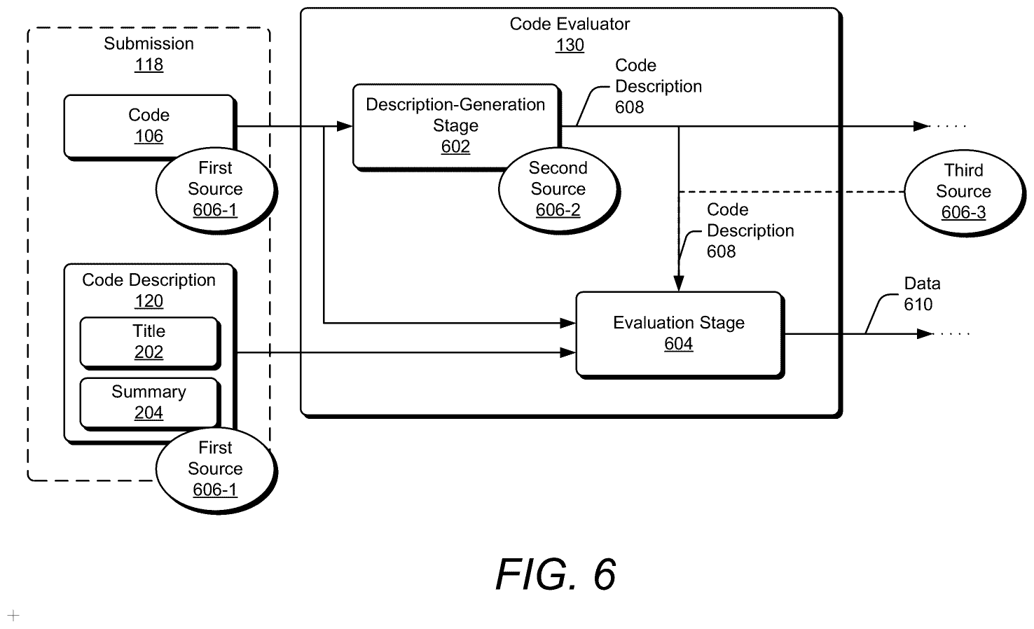

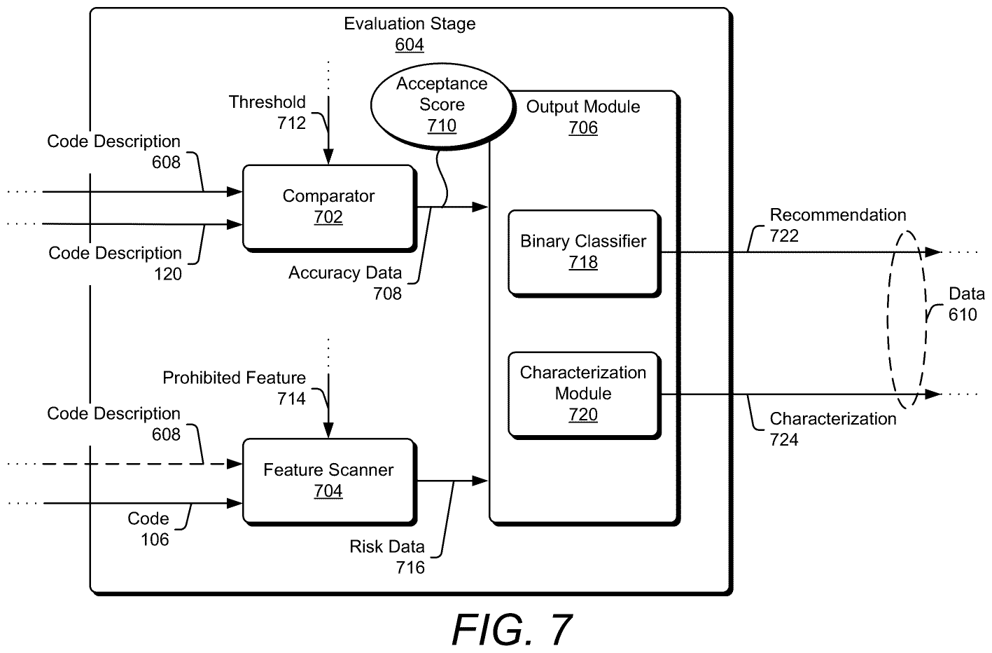

Returning to 122, instead of manually reviewing the code 106 and the code description 120, the approver 124 uses a code evaluator 130, which executes on a computing device 132. The computing device 132 is further described with respect to FIG. 5. The code evaluator 130 evaluates the code 106 and/or the code description 120, and provides easy-to-understand results of the evaluation to the approver 124. Example implementations of the code evaluator 130 are further described with respect to FIGS. 6 and 7. Using the results, the approver 124 can efficiently determine whether to approve or reject the submission 118.

In some implementations, the code evaluator 130 evaluates the code description 120. This is important as the code descriptions 120 of software 128-1 to 128-N on the digital distribution platform 126 can be read by users 108. In a first example, the code evaluator 130 determines an accuracy 134 of the code description 120. The code evaluator 130 can provide an indication to the approver 124 if the code description 120 properly and correctly conveys a function of the code 106. In a second example, the code evaluator 130 evaluates a quality of the code description 120 in terms of clarity, conciseness, spelling, and/or grammar. Code descriptions 120 determined to have higher quality metrics can be easier for users 108 to read and/or understand. The approver 124 can reject a submission 118 if the code evaluator 130 determines that the code description 120 is inaccurate, unclear, verbose, and/or has spelling and/or grammar errors.

Additionally or alternatively, the code evaluator 130 determines that one or more prohibited features are present or absent within the code 106. These prohibited features can potentially compromise a security 136 of the device 110, a safety 138 of the user 108 operating the device 110, a privacy 140 of the user 108, and/or policy compliance 142. Example prohibited features can include malware and/or computer viruses, which can impact the security 136, safety 138, and/or privacy 140. Other prohibited features can include obscene, indecent, and/or profane content, which can impact the policy compliance 142 by violating a policy and/or content standard of the manufacturer.

If the code evaluator 130 determines that the code description 120 is accurate and/or the code 106 does not include the one or more prohibited features, the approver 124 can proceed to approve the submission 118 for inclusion in the digital distribution platform 126. In this case, the code 106 can represent one of the approved software 128-1 to 128-N. Alternatively, if the code evaluator 130 determines that the code description 120 is inaccurate and/or the code 106 includes at least one prohibited feature, the approver 124 can reject the submission 118 and prevent the code 106 from being made available through the digital distribution platform 126. In this way, the manufacturer can ensure that the software 128 that is made available via the digital distribution platform 126 is safe for the user 108 to use on the device 110.

In the approval process described above, the approver 124 is responsible for making the final decision regarding whether the code 106 and the code description 120 can be made available on the digital distribution platform 124. Other automatic and/or semi-automatic approval processes are also possible. In an automatic process, the computing device 132 can directly approve or reject the submission 118 based on the results provided by the code evaluator 130. If an approval occurs, the computing device 132 can automatically update the digital distribution platform 126 to include the approved code 106. In a semi-automatic approval process, submissions 118 that are flagged by the code evaluator 130 as requiring more scrutiny can be passed to the approver 124 for further review. However, other submissions 118 that the code evaluator 130 indicates are safe are automatically made available on the digital distribution platform 126 without requiring further review or approval from the approver 124.

At 144, the user 108 can perform an action, such as by selecting an icon associated with one of the software 128-1 to 128-N, to cause the digital distribution platform 126 to provide the corresponding code description 120 and/or the corresponding code 106 to the user 108. Elements of the code description 120 are further described with respect to FIG. 2.

FIG. 2 illustrates example elements of the code description 120. In the environment 200 shown in FIG. 2, the user 108 accesses the digital distribution platform 126 on the device 110. Through the device 110, the user 108 causes the digital distribution platform 126 to present the code description 120 associated with software 128-1 and 128-2. Each code description 120 includes at least one title 202 and/or at least one summary 204. The title 202 and the summary 204 can also be respectively referred to as a header and a body of the code description 120. Both the title 202 and the summary 204 are formed using plain-text. Generally speaking, the title 202 is shorter than the summary 204. In other words, a length (or a character count) of the title 202 is smaller than a length (or a character count) of the summary 204.

Consider a first example in which the software 128-1 represents an application 112 that can be used to store recipes. In FIG. 2, the title 202 associated with the software 128-1 is indicated in bold font and reads “My Cookbook.” The summary 204 of the software 128-1 reads “Database for storing recipes. Capable of scanning in and parsing recipes from pictures or websites.”

Consider a second example in which the software 128-2 represents a home-automation script 114 for controlling a light in a home-automation system. In FIG. 2, the title 202 associated with the software 128-2 is indicated in bold font and reads “Lights on for Person Detection.” The summary 204 of the software 128-2 reads “Turn on light if the user is detected after dark.” As can be seen in the above examples, the code description 120 informs the user 108 about the purpose of the code and enables the user 108 to determine whether or not they want to install and/or purchase the associated software 128.

In some cases, the device 110 can directly access the digital distribution platform 126 to download the software 128. In other cases, the user 108 can use a different device to access the digital distribution platform 126 and forward the software 128 to the device 110. In some cases, the software 128 can be intended for a home-automation system, which is further described with respect to FIG. 3.

FIG. 3 illustrates an example home-automation system 302, which includes a communication hub 304 and one or more smart devices 306-1 to 306-M, where M represents a positive integer. The communication hub 304 can use any suitable type of data communication for managing (e.g., controlling and/or configuring) the smart devices 306-1 to 306-M. In some implementations, the communication hub 304 can facilitate communication between the smart devices 306-1 to 306-M and/or can enable the smart devices 306-1 to 306-M to connect to the Internet. Example smart devices 306 can include common household objects, devices, and/or appliances. More specifically, some smart devices 306 include a light, a wall-outlet plug, a switch, a computing device, a television, a speaker, a sensor (e.g., a security camera, a water sensor, a temperature sensor, or a smoke alarm), a lock, a doorbell, a fan, a thermostat, a kitchen appliance (e.g., a refrigerator, a microwave, an oven, a coffee maker, and/or a dishwasher), a vacuum, and so forth. In the context of the present disclosure, “smart” can mean electronically connected over a network (not pictured), programmable, capable of automation, or a similar feature set known to a person of ordinary skill in the art.

Consider an example environment 308, which includes a dwelling (e.g., a house) with rooms 310 and 312. The room 310 contains the communication hub 304 and a smart light 314, which represents one of the smart devices 306-1 to 306-M. The room 312 contains a tablet device 316, a smart light 318, a smart sensor 320, a smart television 322, and a smart lock 324, which can represent other ones of the smart devices 306-1 to 306-M.

The data communications between the communication hub 304 and the smart devices 306-1 to 306-M can be carried out using any of a variety of custom or standard wireless protocols (e.g., Wi-Fi®, ZigBee® for low power, 6LoWPAN, or Thread®) and/or by using any of a variety of custom or standard wired protocols (e.g., CAT6 Ethernet or HomePlug). Additionally or alternatively, one or more of the smart devices 306-1 to 306-M can function as the communication hub 304 and can thus serve as an access point for the network for all streaming data. Examples of the network include local area networks (LAN) and wide area networks (WAN) such as the Internet. The network can be implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code-division multiple-access (CDMA), time-division multiple-access (TDMA), Bluetooth®, Wi-Fi®, voice over Internet Protocol (VoIP), WiMAX®, or any other suitable communication protocol.

In the context of the home-automation system 302, the device 110 that executes the software 128 can be the communication hub 304 and/or one or more of the smart devices 306-1 to 306-M. The device 110 is further described with respect to FIG. 4.

FIG. 4 illustrates an example device 110 capable of executing software 128 that has been previously vetted using the code evaluator 130. The device 110 is illustrated with various non-limiting example devices including a desktop computer 110-1, a tablet 110-2, a laptop 110-3, a television 110-4, a computing watch 110-5, computing glasses 110-6, a gaming system 110-7, a microwave 110-8, and a vehicle 110-9. Other devices can also be used, such as a home service device, a component of the home-automation system 302, a baby monitor, a Wi-Fi® router, a drone, a trackpad, a drawing pad, a netbook, an e-reader, a wall display, and another home appliance. Note that the device 110 can be wearable, non-wearable but mobile, or relatively immobile (e.g., desktops and appliances).

The device 110 includes one or more computer processors 402 and at least one computer-readable medium 404, which includes memory media and storage media. Applications and/or an operating system (not shown) embodied as computer-readable instructions on the computer-readable medium 404 can be executed by the computer processor 402 to provide some of the functionalities described herein. The computer-readable medium 404, or alternatively the non-volatile memory within the computer-readable medium 404, can include or otherwise include a non-transitory computer-readable storage medium. In some implementations, the computer-readable medium 404, or the non-transitory computer-readable storage medium of the computer-readable medium 404, stores programs, modules, and data structures, or a subset or superset thereof.

The computer-readable medium 404 includes the software 128, which can be downloaded by the user 108 through the digital distribution platform 126 or forwarded to the device 110 using another device, such as the communication hub 304. The software 128 can be executed using the computer processor 402 or by using another component of the device 110 (e.g., a sensor or a transceiver). As the software 128 was previously vetted using the code evaluator 130 and was made available on the digital distribution platform 126, the user 108 can be confident that the software 128 does not present a significant risk to security 136, safety 138, privacy 140 and/or policy compliance 142, even if the software 128 was developed by a third-part developer 104.

The device 110 can also include a network interface 408 for communicating data over wired, wireless, or optical networks. For example, the network interface 408 may communicate data over a local-area-network (LAN), a wireless local-area-network (WLAN), a personal-area-network (PAN), a wire-area-network (WAN), an intranet, the Internet, a peer-to-peer network, point-to-point network, a mesh network, Bluetooth®, and the like. With the network interface 408, the device 110 can download or otherwise receive the software 128. Some implementations of the device 110 can include a display 410.

### Evaluating Computer-Readable Code

FIG. 5 illustrates an example computing device 132, which is capable of evaluating the code 106. The computing device 132 includes one or more computer processors 502 and at least one computer-readable medium 504, which includes memory media and storage media. Applications and/or an operating system (not shown) embodied as computer-readable instructions on the computer-readable medium 404 can be executed by the computer processor 502 to provide some of the functionalities described herein. The computer-readable medium 504, or alternatively the non-volatile memory within the computer-readable medium 504, can include or otherwise include a non-transitory computer-readable storage medium. In some implementations, the computer-readable medium 504, or the non-transitory computer-readable storage medium of the computer-readable medium 504, stores programs, modules, and data structures, or a subset or superset thereof.

The computer-readable medium 504 includes the code evaluator 130, which performs aspects of evaluating computer-readable code. The code evaluator 130 can be implemented using a machine-learned model 506. The machine-learned model 506 includes at least one artificial neural network (e.g., at least one neural network). A neural network includes a group of connected nodes (e.g., neurons or perceptrons), which are organized into one or more layers. As an example, the machine-learned model 506 includes a deep neural network, which includes an input layer, an output layer, and one or more hidden layers positioned between the input layer and the output layers. The nodes of the deep neural network can be partially-connected or fully connected between the layers.

In some cases, the deep neural network is a recurrent deep neural network (e.g., a long short-term memory (LSTM) recurrent deep neural network) with connections between nodes forming a cycle to retain information from a previous portion of an input data sequence for a subsequent portion of the input data sequence. In other cases, the deep neural network is a feed-forward deep neural network in which the connections between the nodes do not form a cycle. Additionally or alternatively, the machine-learned model 506 can include another type of neural network, such as a convolutional neural network.

In some cases, the machine-learned model 506 is implemented using a large language model 508. The large language model 508 can be an existing large language model with additional training in some implementations. In other implementations, the large language model 508 can be a general large language model, which is not specifically trained to evaluate data associated with the submission 118. Example large language models 508 include LaMDA GLM, Chat GPT, Gopher, Chinchilla, Gemini, PaLM, or a similar large language model.

The machine-learned model 506 (and/or the large language model 508) can be trained using supervised learning techniques. For example, the machine-learned model 506 can be trained on a training dataset that includes training examples labeled as belonging (or not belonging) to one or more classes. In some cases, the machine-learned model 506 can have additional training on specific data types, such as specific types of software programming languages. These specific data types can be, for example, labeled data sets including the code portion and the description portion. The specific data types can also include unlabeled data sets.

Some of the training data can include code 106 with one or more prohibited features as well as code 106 that does not include the one or more prohibited features. The training data can also include code descriptions 120 that are accurate and are of high quality (e.g., clear, concise, and without spelling and/or grammar errors) as well as code descriptions 120 that are inaccurate and/or are of low quality (e.g., unclear, verbose, and with spelling and/or grammar errors).

A transformer algorithm can be used to train the large language model 508 by processing entire sequences in parallel, as opposed to sequential processing of inputs. Sequential input processing can be, for example, used in legacy recurrent neural networks (RNNs), which can result in much longer training times and limited hardware resource usage. By contrast, examples employing transformer algorithms can utilize graphical processing units (GPUs), which can result in much faster training. A typical example of a large language model can employ several billion parameters, thus the need for robust and efficient training is paramount. By using a transformer algorithm, the large language model 508 can be more efficiently trained.

The computing device 132 can also include a network interface 510 for communicating data over wired, wireless, or optical networks. For example, the network interface 510 may communicate data over a local-area-network (LAN), a wireless local-area-network (WLAN), a personal-area-network (PAN), a wire-area-network (WAN), an intranet, the Internet, a peer-to-peer network, point-to-point network, a mesh network, Bluetooth®, and the like. With the network interface 510, the computing device 132 can receive and/or access the submission 118 from the third-party developer 104. In some cases, the network interface 510 enables the computing device 132 to update the digital distribution platform 126 (e.g., to post the vetted code 106 as software 128 on the digital distribution platform 126).

Some implementations of the computing device 132 can include a display 512. The display 512 enables the code evaluator 130 to display the results of the evaluation to the approver 124. Although illustrated as a laptop in FIG. 1, the computing device 132 can be any type of device with a sufficient amount of memory and computation capability to implement the code evaluator 130. Other example computing devices 132 can include a server or a desktop. An example implementation of the code evaluator 130 is further described with respect to FIG. 6.

FIG. 6 illustrates an example implementation of the code evaluator 130 capable of evaluating computer-readable code. In the depicted configuration, the code evaluator 130 includes at least one description-generation stage 602, which is optional in some implementations, and/or at least one evaluation stage 604. The description-generation stage 602 can be coupled to an output of the code evaluator 130 and/or an input of the evaluation stage 604. The evaluation stage 604 is also coupled to the output of the code evaluator 130. In various implementations, the description-generation stage 602 and the evaluation stage 604 can be implemented using separate machine-learned models 506 or can be integrated together and implemented using a single machine-learned model 506.

The code evaluator 130 accepts, at its inputs, the code 106 and the code description 120. The code 106 and the code description 120 are generated by a first source 606-1, which can be the third-party developer 104 of FIG. 1. In the example shown in FIG. 1, the computing device 132 can provide the code 106 and the code description 120 to the code evaluator 130 based on the submission 118. In some implementations, the approver 124 can control or specify which submission 118 is to be passed to the code evaluator 130.

The description-generation stage 602 can be optional. When included within the code evaluator 130, the description-generation stage 602 generates a code description 608 based on the code 106. In this case, the description-generation stage 602 (or more generally the code evaluator 130) represents a second source 606-2, which is different than, and independent from, the first source 606-1. As such, the code description 608 represents an independently-generated reference for evaluating an accuracy and/or a quality of the code description 120 provided by the third-party developer 104. The code description 608 is a plain-text description of the code 106 and can include the title 202 and/or the summary 204.

Some implementations of the description-generation stage 602 can also be trained to generate a description of one or more prohibited features. Consider an example in which the code 106 includes a prohibited feature, such as malware or malicious code. In this case, the description-generation stage 602 can generate the code description 608 to include a description of the prohibited feature. Incorporating this feature into the description-generation stage 602 can reduce a complexity of the evaluation stage 604.

In some implementations, the code evaluator 130 outputs the code description 608, as shown in FIG. 1. The computing device 132 can pass the code description 608 to the display 512. Through the display 512, the approver 124 can easily read and/or reference the code description 608.

Alternatively, the code-evaluator 130 can be implemented without the description-generation stage 602 and can instead receive, at an input, the code description 608 from a third source 606-3. The third source 606-3 is different than, and independent from, the first source 606-1. In some cases, the approver 124 can manually review the code 106 and generate the code description 608 for the evaluation stage 604. In this case, the approver 124 represents the third source 606-3. In other cases, the approver 124 can use another software tool or another machine-learned model to automatically generate the code description 608. In this case, the software tool or other machine-learned model represents the second source 606-3.

The evaluation stage 604 can evaluate an accuracy of the code description 120 associated with the submission 118. In particular, the evaluation stage 604 can determine a level of agreement between the code description 608 and the code description 120 based on a comparison of the code description 608 with the code description 120. In some implementations, the evaluation stage 604 can further evaluate a quality of the code description 120. The quality can be directly determined based on the code description 120 or can be determined based on the comparison. Additionally or alternatively, the evaluation stage 604 can evaluate the code 106 for prohibited features that can negatively impact the security 136, safety 138, privacy 140, and/or policy compliance 142 associated with the device 110.

In various implementations, the evaluation stage 604 accepts, at its input, the code 106, the code description 120, and/or the code description 608. The code description 120 can include the title 202 and/or the summary 204. The evaluation stage 604 generates, at its output, data 610, which represents the results of the evaluation. Example data 610 can be as simple as a “go” or “no-go” recommendation for approving (or denying) the submission 118. Other example data 610 can be more detailed and include information that quantifies a level associated with the accuracy 134, identifies which prohibited feature is present or absent, and/or estimates a level of risk associated with security 136, safety 138, privacy 140, and/or policy compliance 142.

The computing device 132 can pass the data 610 to the display 512 so as to present the data 610 to the approver 124. With the code description 608 and/or the data 610, the approver 124 can quickly determine whether to approve or reject the submission 118. The evaluation stage 604 is further described with respect to FIG. 7.

FIG. 7 depicts an example implementation of the evaluation stage 604, which is capable of performing aspects of evaluating computer-readable code. In the depicted configuration, the evaluation stage 604 includes at least one comparator 702, at least one feature scanner 704, and at least one output module 706. The output module 706 is coupled to the comparator 702, the feature scanner 704, and the outputs of the evaluation stage 604. Although depicted as separate elements, the functionality performed by the comparator 702, the feature scanner 704, and the output module 706 can be integrated within a same machine-learned model 506. In some cases, the comparator 702, the feature scanner 704, and the output module 706 can represent different groups of layers of a deep neural network that implements the evaluation stage 604. In various training examples, the comparator 702 and the feature scanner 704 can be trained together or separately.

The comparator 702 evaluates the accuracy 134 of the code description 120. More specifically, the comparator 702 compares the code description 120 to the code description 608 to determine a level of agreement (e.g., a level of similarity) between the code description 120 and the code description 608. The comparator 702 generates accuracy data 708 based on the comparison. The accuracy data 708 can include a numerical representation of the determined level of agreement between the code descriptions 120 and 608. For example, the accuracy data 708 can include an acceptance score 710, which represents a percentage of similarity between the code descriptions 120 and 608. In this case, an acceptance score 710 of 100% can indicate that the code descriptions 120 and 608 are identical.

In some implementations, the comparator 702 further compares the acceptance score 710 to a threshold 712. The threshold 712 can be set to a value that is greater than or equal to 50%. In example implementations, the threshold 712 can be approximately equal to 75%, 80%, 90%, 95%, and so forth. In general, the threshold 712 can be appropriately set based on an accuracy associated with the generation of the reference code description 608 and/or based on a performance of the comparator 702. In this case, the accuracy data 708 can include an indication of whether the acceptance score 710 is greater than or less than the threshold 712.

The feature scanner 704 evaluates a level of risk that the code 106 presents to the device 110 regarding at least one of the following: security 136, safety 138, the privacy 140 and/or policy compliance 142. More specifically, the feature scanner 704 scans through the code 106 and determines if one or more prohibited features 714 are present (or absent) in the code 106. Example prohibited features 714 can include malware, computer viruses, or other malicious code, which can compromise security 136, safety 138, and/or privacy 140. Other example prohibited features 714 can include code that can present obscene, indecent, and/or profane content on the device 110, which can compromise policy compliance 142 by violating a policy and/or a content standard of the manufacturer. In some cases, the feature scanner 704 is trained to detect multiple prohibited features 714. In this case, the approver 124 or the computing device 132 can select which ones of the multiple prohibited features 714 the feature scanner 704 is to detect.

The feature scanner 704 generates risk data 716 based on the code 106, which can indicate if a prohibited feature 714 is present or absent. In some cases, the risk data 716 can include a level of confidence associated with the determination that a prohibited feature 714 is present or absent. The evaluation stage 604 can be trained using the threshold 712 and/or the prohibited feature 714 as parameters. Other implementations of the feature scanner 704 are also possible in which the feature scanner 704 evaluates the code description 608 to determine if the prohibited feature 714 is present or absent. Generally speaking, the feature scanner 704 can perform this evaluation based on the code 106, the code description 608, or a combination thereof.

The output module 706 processes information provided by the comparator 702 and the feature scanner 704 and generates the data 610 to assist with the approval process. In various implementations, the output module 706 can be implemented using a binary classifier 718 and/or a characterization module 720. The binary classifier 718 can generate a recommendation 722 for approving or rejecting the submission 118. For example, the binary classifier 718 can generate a recommendation 722 for approving the submission 118 based on the accuracy data 708 indicating that the code description 120 is sufficiently accurate (e.g., based on the acceptance score 710 being greater than the threshold 712). Additionally or alternatively, the binary classifier 718 can provide the recommendation 722 for approval based on the risk data 716 indicating that the one or more prohibited features 714 are absent from the code 106.

In another example, the binary classifier 718 can generate a recommendation 722 for rejecting the submission 118 based on the accuracy data 708 indicating that the code description 120 is inaccurate (e.g., based on the acceptance score 710 being less than the threshold 712). Additionally or alternatively, the binary classifier 718 can provide the recommendation 722 for rejection based on the risk data 716 indicating at least one prohibited feature 714 is present in the code 106. In this case, the submission 118 can be flagged for further scrutiny and/or evaluation by the approver 124.

The characterization module 720 can generate a characterization 724 based on the accuracy data 708 and/or the risk data 716. The characterization 724 provides additional information regarding the recommendation 722. This can include a confidence level in the veracity of the recommendation 724 and/or what data impacted the recommendation 724. In some cases, the characterization 724 can directly include the accuracy data 708 and/or the risk data 716.

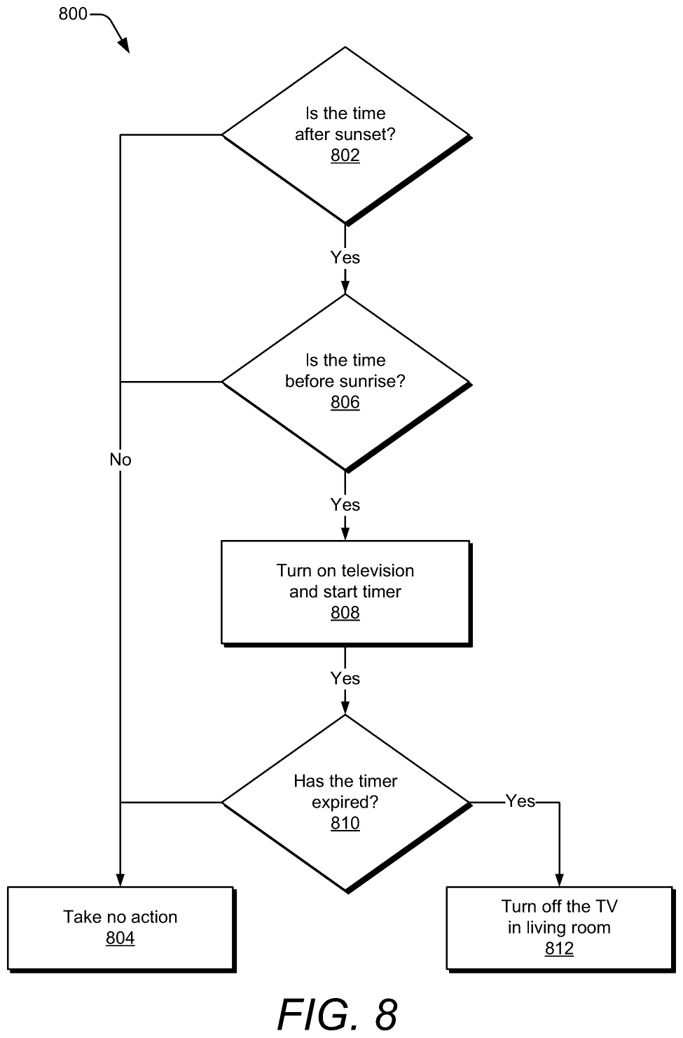

Other implementations of the evaluation stage 604 are also possible, including implementations capable of evaluating the quality of the code description 120. Generally speaking, the evaluation stage 604 can be trained to assess a variety of different types of codes, including applications 112 and/or home-automation scripts 114. Example home-automation scripts 114 are further described with respect to FIGS. 8 to 10.

FIG. 8 illustrates a logical flow 800 for a first example home-automation script 114. Consider a use case in which the user 108 wants to turn on the smart television 322 in the room 312 of FIG. 3 for sixty minutes respondent to meeting the conditions of being after sunset and before sunrise. According to some examples, the user 108 can set this conditionality by requesting a device, such as the communication hub 304, to set up a routine that uses the home-automation script 114 to turn on the smart television 322 in the room 312 at nighttime. A YAML script for such a home-automation request can be similar to the following:

```
type: device.state
  device: TV - Living Room
  trait: OnOff
  state: on
  is: true
condition:
  type: time.between
  after: SUNSET
  before: SUNRISE
    minutes: 60
```

This functionality can be represented with the logical flow 800. Block 802 determines if the time is after sunset. If it is not, then the logic executes block 804, which is taking no action. If it is after sunset, the logic 800 proceeds to block 806 where no action is taken. Block 806 determines if it is before sunrise. If not, again block 804 is executed. If it is before sunrise, the logic 800 proceeds to block 808. In block 808, the smart television 322 in the room 312 is turned on and a timer is started. The logic 800 then proceeds to block 810. In block 810, it can be determined whether the timer has expired (e.g., if sixty minutes has elapsed). If not, block 804 is again executed, in which no action is taken. If so, the logic 800 proceeds to block 812, which results in turning off the smart television 322 in the room 312.

For the above example code 106, the code evaluator 130 can use the description-generation stage 602 to generate the code description 608. The code description 608 can include a title 202, such as “Turn On TV at Nighttime.” Additionally or alternatively, the code description 608 can include a summary 204, such as “this code turns on the television for 60 minutes between sunset and sunrise.” Other equivalent descriptions, including other equivalent titles 202 and/or summaries 204, are also possible.

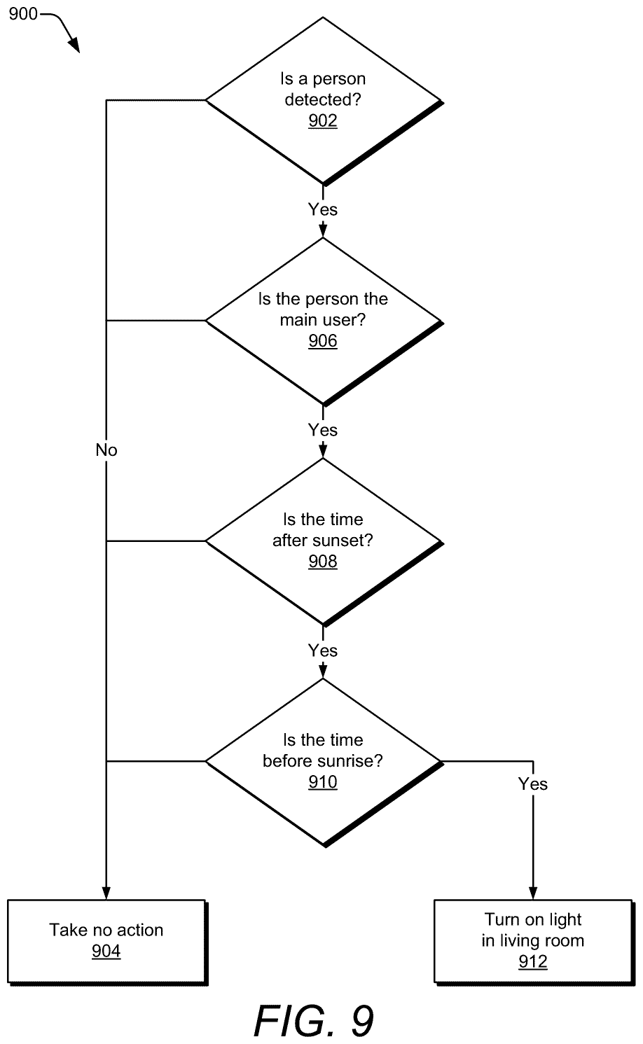

FIG. 9 illustrates a logical flow 900 for a second example home-automation script 114. Consider a use case in which the user 108 wants to turn on the smart light 314 in the room 310 respondent to meeting the conditions of the user 108 being detected by a camera and the time being after sunset and before sunrise. According to some examples, the user 108 can set this conditionality by requesting a device, such as the communication hub 304, to set up a routine that turns on the light 318 in the room 312 subject to the aforementioned conditions. A YAML script for such a home-automation request can be similar to the following:

```
type: binary_sensor.person
entity_id: person.me
trigger:
  platform: time
  after: sunset
  before: sunrise
action:
  service: light.turn_on
data:
  entity_id: light.living_room
```

This functionality can be represented with the logical flow 900. In block 902, it can be determined whether a person has been detected. Person detection can be performed by a camera, infrared sensor, or other device known to a person of ordinary skill in the art to detect a person. If the person is not detected, the logic 900 proceeds to block 904 and no action is taken. If a person is detected, the next step is to determine if the person is the main user. If the person is not determined to be the main user, again block 904 is accessed and no action is taken.

If the detected person is determined to be the main user at block 906, the logic 900 proceeds to block 908, where it is determined if it is after sunset. If not, again block 904 is accessed and no action is taken. If so, block 910 is accessed and a determination is made whether it is before sunrise. If not, again block 904 is accessed and no action is taken. If so, the light 318 in the room 312 is turned on at block 912.

For the above example code 106, the code evaluator 130 can use the description-generation stage 602 to generate the code description 608. The code description 608 can include a title 202, such as “Lights On for Person Detection” or “Turn on the Light when the Main User is Detected after Dark.” Additionally or alternatively, the code description 608 can include a summary 204, such as “this code turns on the living room light if the main user is detected after dark” or “this code sets the living room light to an ‘on’ state if the main user is detected between sunset and sunrise.” Other equivalent descriptions, including other equivalent titles 202 and/or summaries 204, are also possible.

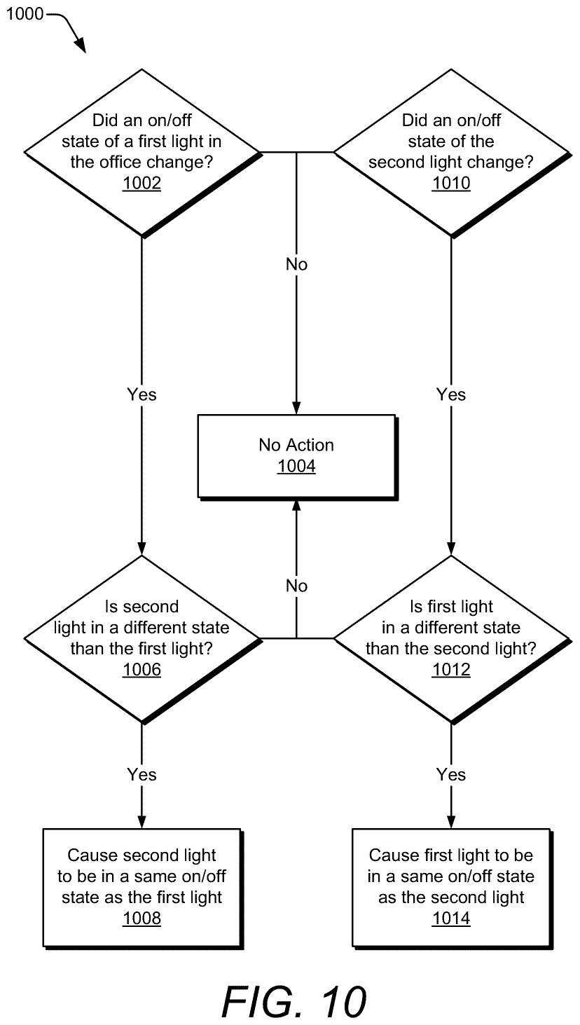

FIG. 10 illustrates a logical flow 1000 for a third example home-automation script 114. Consider a use case in which the user 108 wants to synchronize operation of two lights in different rooms, such as the light 314 in the room 310 and the light 318 in the room 312. According to some examples, the user 108 can set this conditionality by requesting a device, such as the communication hub 304, to set up a routine that coordinates operation of the two lights 314 and 318. A YAML script for such a home-automation request can be similar to the following:

```
starters:
  type: device.state.OnOff
    device: Light A - Office
    state: on
    is: true
  condition:
    type: device.state.OnOff
    device: Light B - Living Room
    state: on
    is: false
  actions:
    type: device.command.OnOff
    device: Light B - Living Room
    on: true
starters:
  type: device.state.OnOff
    device: Light A - Office
    state: on
    is: false
  condition:
    type: device.state.OnOff
    device: Light B - Living Room
    state: on
    is: true
  actions:
    type: device.command.OnOff
    devices: Light B - Living Room
    on: false
starters:
  type: device.state.OnOff
    device: Light B - Living Room
    state: on
    is: true
  condition:
    type: device.state.OnOff
    device: Light A - Office
    state: on
    is: false
  actions:
    type: device.command.OnOff
    device: Light A - Office
    on: true
starters:
  type: device.state.OnOff
    device: Light B - Living Room
    state: on
    is: false
  condition:
    type: device.state.OnOff
    device: Light A - Office
    state: on
    is: true
  actions:
    type: device.command.OnOff
    devices:
    Light A - Office
    on: false
```

This functionality can be represented with the logical flow 1000. At block 1002, it can be determined whether an on/off state of a first light has changed. If the state has not changed, no action is taken at block 1004. Otherwise, the logic 1000 proceeds to block 1006. At block 1006, it can be determined whether a second light is in a different state than the first light. If not, again block 1004 is accessed and no action is taken. Otherwise, the logic 1000 proceeds to block 1008. At block 1008, the second light is made to be in a same on/off state as the first light.

At block 1010, it can be determined whether an on/off state of the second light has changed. If the state has not changed, no action is taken at block 1004. Otherwise, the logic 1000 proceeds to block 1012. At block 1012, it can be determined whether the first light is in a different state than the second light. If not, again block 1004 is accessed and no action is taken. Otherwise, the logic 1000 proceeds to block 1014. At block 1014, the first light is made to be in a same on/off state as the second light. As such, this example home-automation script 114 synchronizes an operation of the first and second lights.

For the above example code 106, the code evaluator 130 can use the description-generation stage 602 to generate the code description 608. The code description 608 can include a title 202, such as “Synchronize two lights.” Additionally or alternatively, the code description 608 can include a summary 204, such as “this code cause two lights to be in a same on/off state.” Other equivalent descriptions, including other equivalent titles 202 and/or summaries 204, are also possible.

For the example code 106 described with respect to FIGS. 8 to 10, the code evaluator 130 can also use the evaluation stage 604 to generate the data 610. In particular, the code evaluator 130 can use the evaluation stage 604 to determine the accuracy 134 and/or to determine if the code 106 introduces a vulnerability or a threat that can negatively impact security 136, safety 138, privacy 140, and/or policy compliance 142.

### Example Method

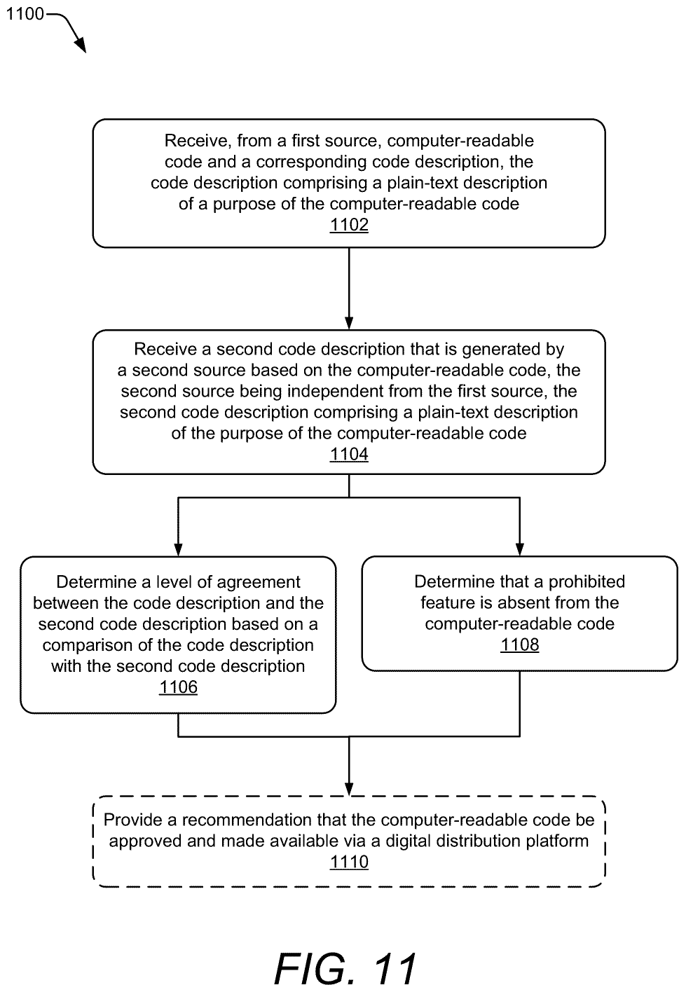

FIG. 11 depicts an example method 1100 for implementing aspects of evaluating computer-readable code. Method 1100 is shown as a set of operations (or acts) performed but not necessarily limited to the order or combinations in which the operations are shown herein. Further, any of one or more of the operations can be repeated, combined, reorganized, or linked to provide a wide array of additional and/or alternate methods. In portions of the following discussion, reference can be made to the environment 100 of FIG. 1, and entities detailed in FIGS. 5 and 6, reference to which is made for example only. The techniques are not limited to performance by one entity or multiple entities operating on one device.

At 1102, computer-readable code and a corresponding code description are received from a first source. The code description comprises a plain-text description of a purpose of the computer-readable code. For example, the code evaluator 130 receives the code 106 and a corresponding code description 120 from a first source 606-1, as shown in FIG. 6. In most situations, the code 106 and the code description 120 are received indirectly from the first source 606-1. For example, the approver 124 and/or the computing device 132 can provide (or pass) the code 106 and the code description 120 to an input of the code evaluator 130. In the examples described above, the first source 606-1 represents the third-party developer 104. The code description 120 includes a plain-text description of a purpose of the code 106. In various implementations, the code description 120 can include a title 202 and/or a summary 204.

At 1104, a second code description that is generated by a second source based on the computer-readable code is received. The second source is independent from the first source. The second code description comprises a plain-text description of the purpose of the computer-readable code.

For example, the code evaluator 130 receives the code description 608, which is generated by a second source 606-2 based on the computer-readable code 106. In some example implementations, the code evaluator 130 represents the second source 606-2 and uses the description-generation stage 602 to generate the code description 608. In other situations, the code description 608 is provided by the approver 124 and/or the computing device 132 to an input of the code evaluator 130. The second source 606-2 is different than, and independent from, the first source 606-1. In this way, the code description 608 represents an independently-generated reference, which can be used by the code evaluator 130 to evaluate the description accuracy 134. The second code description 608 also includes a plain-text description of the purpose of the code 106. The method 1100 can further perform at least one of the steps described at 1106 and/or 1108.

At 1106, a level of agreement between the code description and the second code description is determined based on a comparison of the code description with the second code description. For example, the code evaluator 130 determines a level of agreement between the code description 120 and the code description 608 based on a comparison of the code description 120 with the code description 608. This comparison can be performed using the comparator 702 of FIG. 7.

At 1108, a prohibited feature is determined to be absent from the computer-readable code. For example, the code evaluator 130 determines, using the feature scanner 704, that the prohibited feature 714 is absent from the code 106. If present, the prohibited feature 714 can negatively impact the security 136, safety 138, privacy 140, and/or policy compliance 142 of the device 110.

Optionally at 1110, a recommendation is provided that the computer-readable code be approved and made available via a digital distribution platform. For example, the code evaluator 130 can optionally provide a recommendation that the code 106 be approved and made available to users 108 via the digital distribution platform 126. This recommendation can be based on the level of agreement being greater than the threshold 712 and/or based on the prohibited feature 714 being determined to be absent from the code 106.

### Example Computing System

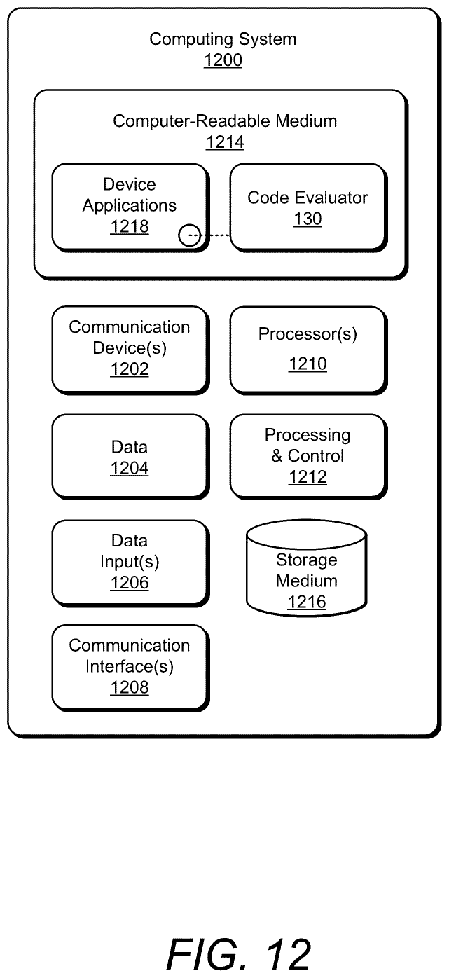

FIG. 12 illustrates various components of an example computing system 1200 that can be implemented as any type of client, server, and/or computing device as described with reference to the previous FIGS. 1 and 5 to implement aspects of evaluating computer-readable code.

The computing system 1200 includes communication devices 1202 that enable wired and/or wireless communication of data 1204 (e.g., received data, data that is being received, data scheduled for broadcast, or data packets of the data). The data 1204 or other device content can include the submission 118 sent by a third-party developer 104. The computing system 1200 includes one or more data inputs 1206 via which any type of data and/or inputs can be received, such as the code 106, the code description 120, the code description 608, the threshold 712, and/or the prohibited feature 714.

The computing system 1200 also includes communication interfaces 1208, which can be implemented as any one or more of a serial and/or parallel interface, a wireless interface, any type of network interface, a modem, and as any other type of communication interface. The communication interfaces 1208 provide a connection and/or communication links between the computing system 1200 and a communication network by which other electronic, computing, and communication devices communicate data with the computing system 1200. The communication interface 1208 can enable the computing system 1200 to receive the submission 118 and/or can enable any vetted software 128 to be sent to a server that hosts the digital distribution platform 126.

The computing system 1200 includes one or more processors 1210 (e.g., any of microprocessors, controllers, and the like), which process various computer-executable instructions to control the operation of the computing system 1200. Alternatively or in addition, the computing system 1200 can be implemented with any one or combination of hardware, firmware, or fixed logic circuitry that is implemented in connection with processing and control circuits which are generally identified at 1212. Although not shown, the computing system 1200 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computing system 1200 also includes a computer-readable medium 1214, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. The disk storage device may be implemented as any type of magnetic or optical storage device, such as a hard disk drive, a recordable and/or rewriteable compact disc (CD), any type of a digital versatile disc (DVD), and the like. The computing system 1200 can also include a mass storage medium device (storage medium) 1216.

The computer-readable medium 1214 provides data storage mechanisms to store the data 1204, as well as various device applications 1218 and any other types of information and/or data related to operational aspects of the computing system 1200. For example, an operating system can be maintained as a computer application with the computer-readable medium 1214 and executed on the processors 1210. The device applications 1218 may include a device manager, such as any form of a control application, software application, signal-processing and control module, code that is native to a particular device, a hardware abstraction layer for a particular device, and so on.

The device applications 1218 also include any system components, engines, or managers for evaluating computer-readable code. In this example, the device applications 1218 include the code evaluator 130 of FIGS. 1 and 6.

### Conclusion

Although techniques using, and apparatuses including, evaluating computer-readable code have been described in language specific to features and/or methods, it is to be understood that the subject of the appended claims is not necessarily limited to the specific features or methods described. Rather, the specific features and methods are disclosed as example implementations of evaluating computer-readable code.

Some Examples are described below.

Example 1: A method performed by a machine-learned model, the method comprising:
receiving, from a first source, a computer-readable code and a corresponding code description, the code description comprising a plain-text description of a purpose of the computer-readable code;
receiving a second code description that is generated by a second source based on the computer-readable code, the second source being independent from the first source, the second code description comprising a plain-text description of the purpose of the computer-readable code; and
performing at least one of the following:
   determining a level of agreement between the code description and the second code description based on a comparison of the code description with the second code description; or
   determining that a prohibited feature is absent from the computer-readable code.

Example 2: The method of example 1 or any other example, wherein:
the performing comprises determining that the prohibited feature is absent from the computer-readable code; and
the method further comprises:
   providing a recommendation that the computer-readable code be approved and made available via a digital distribution platform based on the determining that the prohibited feature is absent.

Example 3: The method of example 1 or any other example, wherein:
the performing comprises determining the level of agreement; and
the method further comprises:
   providing a recommendation that the computer-readable code be approved for inclusion in a digital distribution platform based on the level of agreement being greater than a threshold.

Example 4: The method of example 1 or any other example, wherein:
the second source comprises the machine-learned model; and
the receiving of the second code description comprises generating the second code description based on the computer-readable code.

Example 5: The method of example 1 or any other example, further comprising:
receiving, from a third source, a second computer-readable code and a corresponding third code description, the third code description comprising a plain-text description of a purpose of the second computer-readable code;
receiving a fourth code description that is generated by the second source based on the second computer-readable code, the second source being independent from the third source, the fourth code description comprising a plain-text description of the purpose of the second computer-readable code; and
performing at least one of the following:
   determining a level of agreement between the third code description and the fourth code description based on a comparison of the third code description with the fourth code description; or
   determining that the prohibited feature is present in the second computer-readable code.

Example 6: The method of example 5 or any other example, further comprising:
providing a recommendation that the computer-readable code be rejected and not made available via a digital distribution platform based on the determining that the prohibited feature is present.

Example 7: The method of example 5 or any other example, further comprising:
providing a recommendation that the computer-readable code be rejected and not made available via a digital distribution platform based on the level of agreement being less than a threshold.

Example 8: The method of example 5 or any other example, wherein the prohibited feature is associated with at least one of the following:
a first risk of compromising a security of a device that is capable of executing the computer-readable code;
a second risk of compromising a safety of a user who operates the device;
a third risk of compromising the user's privacy; or
a fourth risk of violating a policy of a manufacturer of the device.

Example 9: The method of example 8, wherein:
the device comprises a computing device and the computer-readable code comprise a third-party application capable of executing on the computing device; or
the device comprises a home-automation system and the computer-readable code comprise a third-party home-automation script capable of executing on the home-automation system.

Example 10: A non-transitory computer-readable storage medium comprising instructions that, responsive to execution by a processor, cause the processor to implement a machine-learned model, the machine-learned model configured to:
receive, from a first source, a computer-readable code and a corresponding code description, the code description comparing a plain-text description of a purpose of the computer-readable code;
receive a second code description that is generated by a second source based on the computer-readable code, the second source being independent from the first source, the second code description comprising a plain-text description of the purpose of the computer-readable code; and
perform at least one of the following:
   determine a level of agreement between the code description and the second code description based on a comparison of the code description with the second code description; or
   determine that a prohibited feature is absent from the computer-readable code.

Example 11: The non-transitory computer-readable storage medium of example 10 or any other example, wherein the machine-learned model is configured to:
determine that the level of agreement is greater than a threshold;
determine that the prohibited feature is absent from the computer-readable code; and
provide a recommendation that the computer-readable code be approved and made available via a digital distribution platform based on the determination that the level of agreement is greater than the threshold and based on the determination that the prohibited feature is absent.

Example 12: The non-transitory computer-readable storage medium of example 10 or any other example, wherein:
the second source comprises the machine-learned model; and
the machine-learned model is further configured to generate the second code description based on the computer-readable code.

Example 13: The non-transitory computer-readable storage medium of example 10 or any other example, wherein the machine-learned model is configured to:
receive, from a third source, a second computer-readable code and a corresponding third code description, the third code description comprising a plain-text description of a purpose of the second computer-readable code;
receive a fourth code description that is generated by the second source based on the second computer-readable code, the second source being independent from the third source, the fourth code description comprising a plain-text description of the purpose of the second computer-readable code; and
perform at least one of the following:
   determine a level of agreement between the third code description and the fourth code description based on a comparison of the third code description with the fourth code description; or
   determine that the prohibited feature is present in the second computer-readable code.

Example 14: The non-transitory computer-readable storage medium of example 13 or any other example, wherein the machine-learned model is configured to:
determine that the level of agreement is less than a threshold;
determine that the prohibited feature is present in the computer-readable code; and
provide a recommendation that the computer-readable code be rejected and not made available via a digital distribution platform based on the determination that the level of agreement is less than the threshold and based on the determination the prohibited feature is present.

Example 15: The non-transitory computer-readable storage medium of example 13 or any other example, wherein the prohibited feature is associated with at least one of the following:
a first risk of compromising a security of a device that is capable of executing the computer-readable code;
a second risk of compromising a safety of a user who operates the device;
a third risk of compromising the user's privacy; or
a fourth risk of violating a policy of a manufacturer of the device.

Example 16: An apparatus comprising:
a machine-learned model configured to:
   receive, from a first source, a computer-readable code and a corresponding code description, the code description comparing a plain-text description of a purpose of the computer-readable code;
   receive a second code description that is generated by a second source based on the computer-readable code, the second source being independent from the first source, the second code description comprising a plain-text description of the purpose of the computer-readable code; and
   perform at least one of the following:
      determine a level of agreement between the code description and the second code description based on a comparison of the code description with the second code description; or
      determine that a prohibited feature is absent from the computer-readable code.

Example 17: The apparatus of example 16 or any other example, wherein:
the second source comprises the machine-learned model; and
the machine-learned model is further configured to generate the second code description based on the computer-readable code.

Example 18: The apparatus of example 16 or any other example, wherein the machine-learned model is configured to:
determine that the level of agreement is greater than a threshold;
determine that the prohibited feature is absent from the computer-readable code; and
provide a recommendation that the computer-readable code be approved and made available via a digital distribution platform based on the determination that the level of agreement is greater than the threshold and based on the determination that the prohibited feature is absent.

Example 19: The apparatus of example 16, wherein the machine-learned model is configured to:
receive, from a third source, a second computer-readable code and a corresponding third code description, the third code description comprising a plain-text description of a purpose of the second computer-readable code;
receive a fourth code description that is generated by the second source based on the second computer-readable code, the second source being independent from the third source, the fourth code description comprising a plain-text description of the purpose of the second computer-readable code; and
perform at least one of the following:
   determine a level of agreement between the third code description and the fourth code description based on a comparison of the third code description with the fourth code description; or
   determine that the prohibited feature is present in the second computer-readable code.

Example 20: The apparatus of example 16 or any other example, wherein the prohibited feature is associated with at least one of the following:
a first risk of compromising a security of a device that is capable of executing the computer-readable code;
a second risk of compromising a safety of a user who operates the device;
a third risk of compromising the user's privacy; or
a fourth risk of violating a policy of a manufacturer of the device.

What is claimed is:

1. A method performed by a machine-learned model, the method comprising:
receiving, from a first source, a computer-readable code and a corresponding code description, the code description comprising a plain-text description of a purpose of the computer-readable code;
receiving a second code description that is generated by a second source based on the computer-readable code, the second source being independent from the first source, the second code description comprising a plain-text description of the purpose of the computer-readable code; and
performing at least one of the following:
determining a level of agreement between the code description and the second code description based on a comparison of the code description with the second code description; or
determining that a prohibited feature is absent from the computer-readable code.

2. The method of claim 1, wherein:
the performing comprises determining that the prohibited feature is absent from the computer-readable code; and
the method further comprises:
providing a recommendation that the computer-readable code be approved and made available via a digital distribution platform based on the determining that the prohibited feature is absent.

3. The method of claim 1, wherein:
the performing comprises determining the level of agreement; and
the method further comprises:
providing a recommendation that the computer-readable code be approved for inclusion in a digital distribution platform based on the level of agreement being greater than a threshold.

4. The method of claim 1, wherein:
the second source comprises the machine-learned model; and
the receiving of the second code description comprises generating the second code description based on the computer-readable code.

5. The method of claim 1, further comprising:
receiving, from a third source, a second computer-readable code and a corresponding third code description, the third code description comprising a plain-text description of a purpose of the second computer-readable code;
receiving a fourth code description that is generated by the second source based on the second computer-readable code, the second source being independent from the third source, the fourth code description comprising a plain-text description of the purpose of the second computer-readable code; and
performing at least one of the following:
determining a level of agreement between the third code description and the fourth code description based on a comparison of the third code description with the fourth code description; or
determining that the prohibited feature is present in the second computer-readable code.

6. The method of claim 5, further comprising:
providing a recommendation that the computer-readable code be rejected and not made available via a digital distribution platform based on the determining that the prohibited feature is present.

7. The method of claim 5, further comprising:
providing a recommendation that the computer-readable code be rejected and not made available via a digital distribution platform based on the level of agreement being less than a threshold.

8. The method of claim 5, wherein the prohibited feature is associated with at least one of the following:
a first risk of compromising a security of a device that is capable of executing the computer-readable code;
a second risk of compromising a safety of a user who operates the device;
a third risk of compromising the user's privacy; or
a fourth risk of violating a policy of a manufacturer of the device.

9. The method of claim 8, wherein:
the device comprises a computing device and the computer-readable code comprise a third-party application capable of executing on the computing device; or
the device comprises a home-automation system and the computer-readable code comprise a third-party home-automation script capable of executing on the home-automation system.

10. A non-transitory computer-readable storage medium comprising instructions that, responsive to execution by a processor, cause the processor to implement a machine-learned model, the machine-learned model configured to:
receive, from a first source, a computer-readable code and a corresponding code description, the code description comparing a plain-text description of a purpose of the computer-readable code;
receive a second code description that is generated by a second source based on the computer-readable code, the second source being independent from the first source, the second code description comprising a plain-text description of the purpose of the computer-readable code; and
perform at least one of the following:
determine a level of agreement between the code description and the second code description based on a comparison of the code description with the second code description; or
determine that a prohibited feature is absent from the computer-readable code.

11. The non-transitory computer-readable storage medium of claim 10, wherein the machine-learned model is configured to:
determine that the level of agreement is greater than a threshold;
determine that the prohibited feature is absent from the computer-readable code; and
provide a recommendation that the computer-readable code be approved and made available via a digital distribution platform based on the determination that the level of agreement is greater than the threshold and based on the determination that the prohibited feature is absent.

12. The non-transitory computer-readable storage medium of claim 10, wherein:
the second source comprises the machine-learned model; and
the machine-learned model is further configured to generate the second code description based on the computer-readable code.

13. The non-transitory computer-readable storage medium of claim 10, wherein the machine-learned model is configured to:
receive, from a third source, a second computer-readable code and a corresponding third code description, the third code description comprising a plain-text description of a purpose of the second computer-readable code;
receive a fourth code description that is generated by the second source based on the second computer-readable code, the second source being independent from the third source, the fourth code description comprising a plain-text description of the purpose of the second computer-readable code; and
perform at least one of the following:
determine a level of agreement between the third code description and the fourth code description based on a comparison of the third code description with the fourth code description; or
determine that the prohibited feature is present in the second computer-readable code.

14. The non-transitory computer-readable storage medium of claim 13, wherein the machine-learned model is configured to:
determine that the level of agreement is less than a threshold;
determine that the prohibited feature is present in the computer-readable code; and
provide a recommendation that the computer-readable code be rejected and not made available via a digital distribution platform based on the determination that the level of agreement is less than the threshold and based on the determination the prohibited feature is present.

15. The non-transitory computer-readable storage medium of claim 13, wherein the prohibited feature is associated with at least one of the following:
a first risk of compromising a security of a device that is capable of executing the computer-readable code;
a second risk of compromising a safety of a user who operates the device;
a third risk of compromising the user's privacy; or
a fourth risk of violating a policy of a manufacturer of the device.

16. An apparatus comprising:
a machine-learned model configured to:
receive, from a first source, a computer-readable code and a corresponding code description, the code description comparing a plain-text description of a purpose of the computer-readable code;
receive a second code description that is generated by a second source based on the computer-readable code, the second source being independent from the first source, the second code description comprising a plain-text description of the purpose of the computer-readable code; and
perform at least one of the following:
determine a level of agreement between the code description and the second code description based on a comparison of the code description with the second code description; or
determine that a prohibited feature is absent in the computer-readable code.

17. The apparatus of claim 16, wherein:
the second source comprises the machine-learned model; and
the machine-learned model is further configured to generate the second code description based on the computer-readable code.

18. The apparatus of claim 16, wherein the machine-learned model is configured to:
determine that the level of agreement is greater than a threshold;
determine that the prohibited feature is absent in the computer-readable code; and
provide a recommendation that the computer-readable code be approved and made available via a digital distribution platform based on the determination that the level of agreement is greater than the threshold and based on the determination that the prohibited feature is absent.

19. The apparatus of claim 16, wherein the machine-learned model is configured to:
receive, from a third source, a second computer-readable code and a corresponding third code description, the third code description comprising a plain-text description of a purpose of the second computer-readable code;
receive a fourth code description that is generated by the second source based on the second computer-readable code, the second source being independent from the third source, the fourth code description comprising a plain-text description of the purpose of the second computer-readable code; and
perform at least one of the following:
determine a level of agreement between the third code description and the fourth code description based on a comparison of the third code description with the fourth code description; or
determine that the prohibited feature is present in the second computer-readable code.

20. The apparatus of claim 16, wherein the prohibited feature is associated with at least one of the following:
a first risk of compromising a security of a device that is capable of executing the computer-readable code;
a second risk of compromising a safety of a user who operates the device;
a third risk of compromising the user's privacy; or
a fourth risk of violating a policy of a manufacturer of the device.
